(19) United States
(12) Patent Application Publication
(10) Pub. No.: US 2003/0163571 A1
(43) Pub. Date: Aug. 28, 2003

(54) Inter-network connection setup through a transit network

(75) Inventors: Martin Pellert, Munich (DE); Werner Stoeckl, Baierbrunn (DE)

Correspondence Address: T. Lester Wallace, Suite 280, 7041 Koll Center Parkway, Pleasanton, CA, 94566, US

(73) Assignee: Siemens Aktiengesellschaft

(21) Appl. No.: 10/222,649

(22) Filed: Aug. 15, 2002

(30) Foreign Application Priority Data
Feb. 25, 2002 (DE) 10207976.5

(51) Int. Cl. G06F 15/16

(52) U.S. Cl. 709/227

(57) ABSTRACT

In order to set up an inter-network connection, a local connection setup message is transmitted between local and transit networks. The receipt of the local connection setup message at an entry point into a transit network initiates the setup of a transit network connection through the transit network. The local connection setup message is delayed at the entry point by a preset delay time period before being passed on through the transit network to set up an inter-network connection. The delay time period is chosen so that the setup of the transit network connection is complete when the transit network connection is required for establishing the inter-network connection through the transit network. Subsequent delay time periods can be adjusted as a function of the difference between past setup times for the inter-network connection and for the transit network connection.

### CROSS REFERENCE TO RELATED APPLICATION

This application is based on and hereby claims priority to German Application No. 102 07 976.5 filed on Feb. 25, 2002, in Germany, the contents of which are hereby incorporated by reference.

### TECHNICAL FIELD

The present invention relates to setting up network connections over a plurality of communications networks. More specifically, the invention relates to setting up an inter-network connection through a transit network connection.

### BACKGROUND

To set up connections in contemporary communications systems, for example, voice, video and multimedia connections, the connections must be estabished over a plurality of communications networks. Such networks include both long distance networks that function as transit networks, as well as local networks. A long distance network may be a Wide Area Network (WAN), and a local network may be a Local Area Network (LAN). A different connection setup protocol is frequently used in the long distance transit network from that used in the local networks, which contain the source and destination points of a connection.

A typical use for establishing connections over local and transit networks is the setting up of a narrowband inter-network connection over a broadband network that functions as a transit network. In this example, the narrowband inter-network connection can be a real time voice communication. In order to set up such a narrowband inter-network connection, it is necessary to perform narrowband signaling between the source and destination of the connection in accordance with a local connection setup protocol. In addition, however, it is also necessary to perform signaling in accordance with a broadband connection setup protocol in order to set up a broadband user data connection via the broadband network.

According to the prior art, such a broadband transit connection is set up completely before sending a narrowband connection setup message into the broadband network. Once the setup of the broadband transit connection has been confirmed, the narrowband connection setup message is transferred through the broadband network into the target network, and the narrowband connection setup can be continued. This method ensures that the broadband transit connection is set up by the time it is required for the transmission of the narrowband connection setup message.

The total time period that is required to setup the narrowband inter-network connection between the source and destination points is the sum of the setup times for a pure narrowband inter-network connection and a pure broadband transit connection. In comparison with a pure narrowband inter-network connection, the setup time for a narrowband connection that is routed through a broadband transit network having a different connection setup protocol can thus become considerably longer. These longer setup times can together lead to considerable delays, in particular when there are connections that are routed over a plurality of transit networks.

Thus, setting up an inter-network connection using a narrowband connection setup message that is transmitted between networks over a transit network that uses a connection setup protocol specific to the transit network involves waiting for the sum of the setup times for the inter-network connection and the connection of each transit network. A method is therefore sought that reduces the time to setup an inter-network connection using a narrowband connection setup message that is transmitted between networks over a transit network. An apparatus is desired that carries out the faster setup.

### SUMMARY

A local connection setup message is transmitted between networks in order to set up an inter-network connection. According to an embodiment of the invention, the receipt of a local connection setup message at an entry point of a transit network initiates the setup of a transit network connection.

The local connection setup message is delayed at an entry point of the transit network by a preset delay time period before being passed on through the transit network. The delay time period is set so that the setup of the transit network connection is essentially completed if the latter is required to establish the inter-network connection through the transit network.

An interworking unit is placed at the entry point into the transit network and receives the local connection setup message. The interworking unit can be, for example, a bridge, a gateway or a router. The interworking unit has a timing gate that delays the passing on of the local connection setup message. The local connection setup message is buffered in a memory and then, after a delay time period, passed on by a connection controller that interfaces the transit network. The local connection setup message passes through the transit network and sets up the inter-network connection.

The interworking unit also has a time measuring device that measures the setup time for the inter-network connection and the setup time for the transit network connection. The delay time period is set such that the setup of the transit network connection is essentially complete when the transit network connection is required to establish the inter-network connection through the transit network. A delay adjustment device sets subsequent delay time periods for subsequent local connection setup messages as a function of the difference between the previous setup time for the inter-network connection and the previous setup time for the transit network connection.

The method disclosed for setting up of the inter-network connection is faster than under the prior art. The local connection setup message is passed on through the transit network after a preset delay time period and without waiting for the transit network connection to be completely set up. Under the disclosed method, the local connection setup message will generally have been passed on while the transit network connection is still being set up. In this way, the setup of the inter-network connection and the set up of the transit network connection are made to occur at least partially simultaneously.

The method has a further advantage in that it can be implemented by making only slight changes to existing communications systems. Only a small intervention into connection signaling is necessary, and no changes are necessary at the end points of the inter-network connection.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified schematic diagram of a system for setting up an inter-network connection.

FIG. 2 is a diagram of an interworking unit for setting up an inter-network connection between two networks.

FIG. 3 is a flowchart showing the signaling traffic during the setup of an inter-network connection.

### DETAILED DESCRIPTION

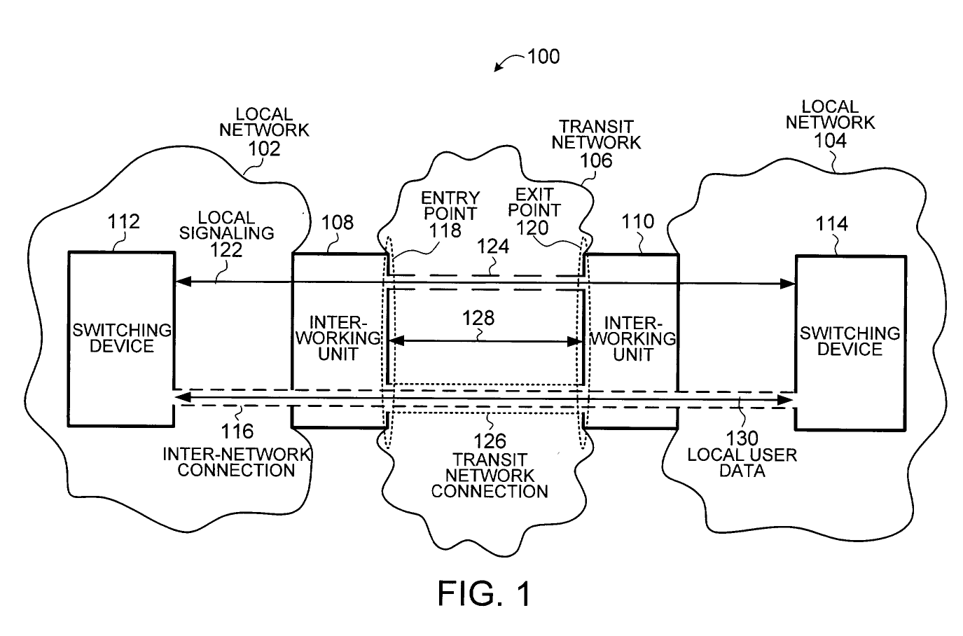

Reference will now be made in detail to some embodiments of the invention, examples of which are illustrated in the accompanying drawings. FIG. 1 is a schematic illustration of a communications system 100 with a first local network 102 and a second local network 104. Real-time voice communication is to be provided by the local networks, which are connected by a transit network 106. The transit network 106 provides a transit connection between the first local network 102 and the second local network 104.

The transit network 106 can, for example, be a local area network (LAN), a long distance network, a wide area network (WAN), the Internet, a backbone network, or an ATM (Asynchronous Transfer Mode) network. Although the transit network 106 would commonly be a broadband network, a narrowband network could also function as a transit network. Each of the local networks 102, 104 can operate as either a circuit-switched communications network or a packet-oriented communications network. Although the local networks 102 and 104 can be narrowband networks, broadband local networks can also be connected by transit networks.

In this embodiment, where a local network operates as a packet-oriented network, the local network permits the setup of switched virtual circuits (also called virtual channels), for example, according to an ATM protocol, MPLS (Multi-Protocol Label Switching) protocol or the ITU-T Recommendation H.323. A connection setup under this embodiment applies to any desired data stream.

In order to set up user data connections, a transit connection setup protocol is used to setup a connection in the transit network 106, and a local connection setup protocol is used to setup a connection in each of the local networks 102 and 104. According to this embodiment, connections are set up in a combination of transit networks and local networks. The application of the invention need not be restricted to broadband and narrowband networks. Instead, the invention can be applied to any desired combination of communications networks having different connection setup protocols.

The transit network 106 is connected to the local network 102 by an interworking unit 108, and to the local network 104 via an interworking unit 110. Each interworking unit 108 and 110 can be implemented, for example, as a gateway device, a bridge, or a router device.

In this embodiment, the local network 102 contains a switching device 112 that is to be connected to a second switching device 114 in the second local network 104 through an inter-network user data connection 116. The switching devices 112 and 114 can be public branch exchanges (PBXs) or network nodes of the local networks 102 and 104, respectively. In another embodiment, each switching devices 112 and 114 can be replaced with a communications terminating device, a personal computer, a client application or a communications server.

The inter-network connection 116, which is to be set up, runs from the local network 102 to the local network 104 through the interworking unit 108. The interworking unit 108 is situated at an entry point 118 into the transit network 106, and the interworking unit 110 is situated at an exit point 120 from the transit network 106.

The setup of the inter-network connection 116 is initiated by sending local signaling 122 between the switching devices 112 and 114 that complies with the local connection setup protocol. The local signaling 122 is transmitted through the transit network 106 within a transit signaling tunnel connection 124 that is set up between the interworking units 108 and 110. The transit signaling tunnel connection 124 is indicated by dashed lines in FIG. 1. The transit signaling tunnel connection 124 is preferably set up as a dedicated signaling connection in advance the steps to establish the inter-network connection 116. The transit signaling tunnel connection 124 is commonly referred to as an AAL5 (ATM Adaptation Layer) connection.

It is generally less expensive to set up a signaling tunnel connection than to set up user data dedicated connection, such as the inter-network user data connection 116. It may even be acceptable, in terms of cost, to set up dedicated signaling tunnel connections between a plurality of, or all of, the interworking units connected to a transit network. Setting up dedicated signaling connections, such as transit signaling tunnel connection 124, in advance has the advantage that local signaling 122 can be transmitted very quickly through the transit network 106.

By means of the local signaling 122, the interworking units 108 and 110 are made to set up a transit network connection 126 between them. The transit network connection 126 is a user data connection that is referred to as an AAL1 connection. The transit network connection 126 is set up by sending transit signaling 128 between the interworking units 108 and 110 that complies with the transit connection setup protocol. The transit network connection 126 is indicated by means of narrow dashed lines in FIG. 1.

The inter-network connection 116 that is to be set up between the switching devices 112 and 114 is routed through the transit network 106 via the transit network connection 126, which itself is set up between the interworking units 108 and 110. The method according to the invention ensures, with a high degree of probability, that the setup of the transit network connection 126 is essentially completed by the time the transit network connection 126 is required to route the inter-network connection 116 through the transit network 106.

After the setup of the inter-network connection 116, local user data 130 is finally transmitted in a transparent fashion within the inter-network connection 116 between the switching devices 112 and 114. The inter-network connection 116 is indicated in FIG. 1 by dashed lines.

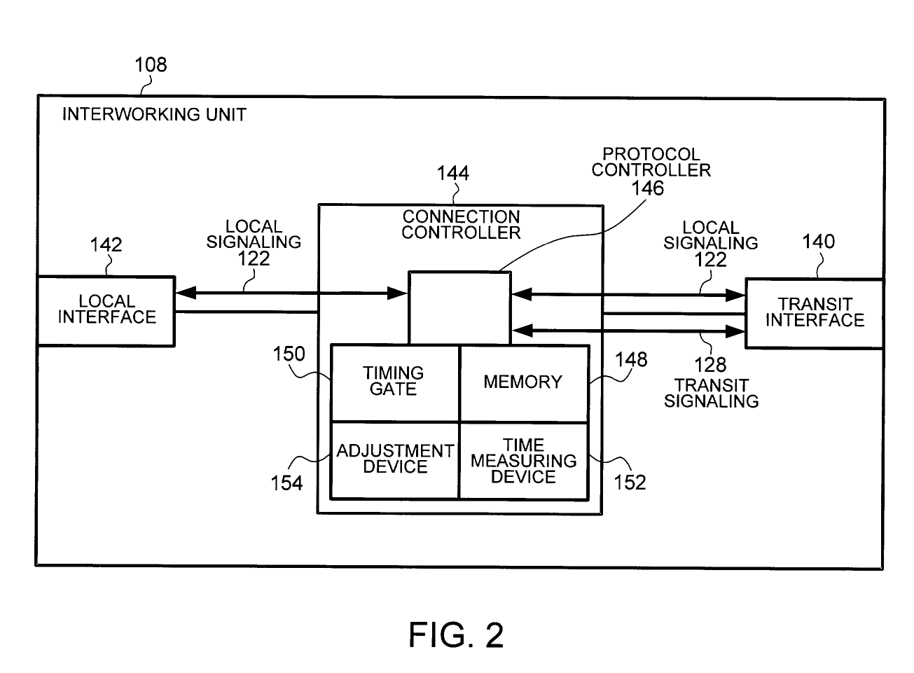

FIG. 2 shows the interworking unit 108. The interworking unit 108 has a transit interface 140 for connecting to the transit network 106 and a local interface 142 for connecting the local network 102. Furthermore, the interworking unit 108 has a connection controller 144 that is connected to the transit interface 140 and the local interface 142. The connection controller 144 contains a protocol controller 146 for processing both the local connection setup protocol and the transit connection setup protocol, a memory 148 that stores connection setup protocol messages, a timing gate 150 for delaying connection setup protocol messages by a preset delay time period 156, a time measuring device 152, and an adjustment device 154 for setting the delay time period. The memory 148, the timing gate 150, the time measuring device 152 and the adjustment device 154 are connected to the protocol controller 146.

The protocol controller 146 exchanges the transit signaling 128 with the transit network 106 through the transit interface 140. The protocol controller 146 also exchanges the local signaling 122, which is transmitted within the transit signaling tunnel connection 124, with the transit network 106 through the transit interface 140

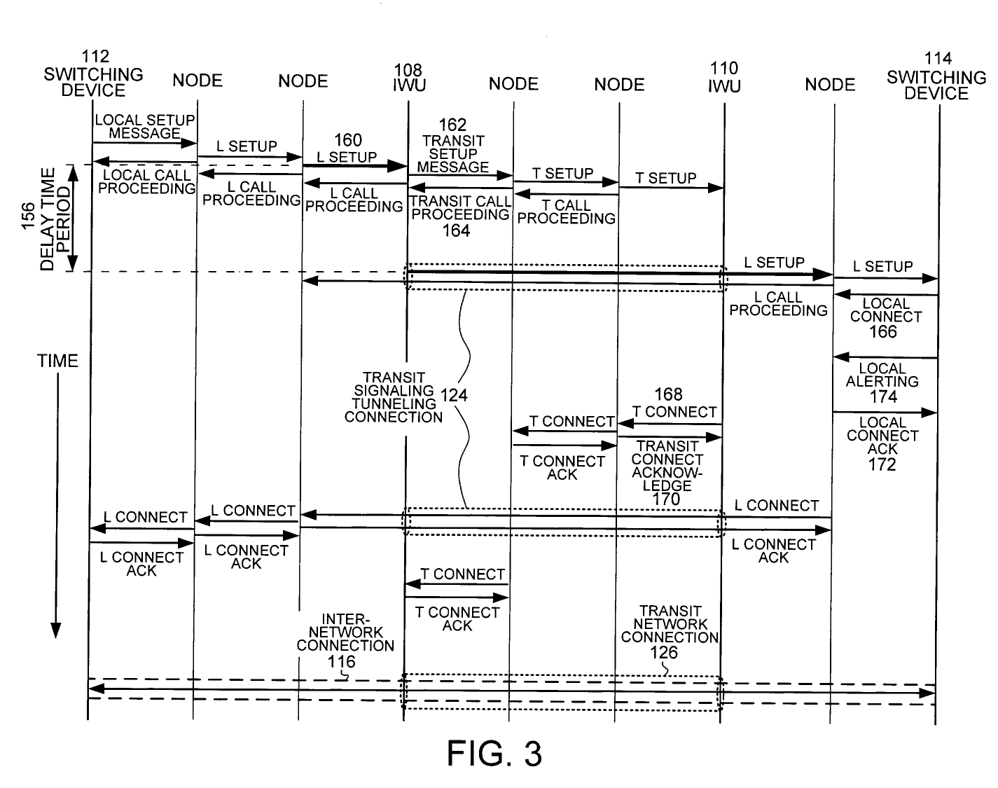

FIG. 3 shows a flowchart illustrating the signaling traffic between the switching devices 112 and 114, as well as between the interworking units 108 and 110, for setting up the inter-network connection 116. The time axis runs from top to bottom in FIG. 3.

In this embodiment, the switching device 112 initiates the setup of the inter-network connection 116 by transferring a local connection setup message 160 to the interworking unit 108 using the local signaling 122. The interworking unit 108 receives the local connection setup message 160 via the local interface 142 and feeds it to the protocol controller 146.

Upon receipt of the local connection setup message 160, the connection controller 144 immediately sends a transit connection setup message 162 into the transit network 106. The transit connection setup message 162 is specific to the transit network 106 and sets up the transit network connection 126. The transit connection setup message 162 is transmitted into the transit network 106 via the transit interface 140 using the transit signaling 128.

The interworking unit 108 receives the local connection setup message 160, but does not initially pass it on through the signaling tunneling connection 124. Instead, the interworking unit 108 buffers the local connection setup message 160 in the memory 148. The timing gate 150 delays the passing on of the buffered local connection setup message 160 by the preset delay time period 156, which is measured from the receipt by the interworking unit 108 of the local connection setup message 160.

The delay time period 156 is set such that the setup of the transit network connection 126 is essentially complete if the transit network connection 126 is required for the routing of the inter-network connection 116. In that case, the transit network connection 126 is established by the time it is required for establishing the inter-network connection 116 through the transit network 106.

The setup times for the inter-network connection 116 and the transit network connection 126 are measured by the time measuring device 152. Then the delay time period 156 for a subsequent local connection setup message is set by the adjustment device 154 as a function of the difference between the setup time for the inter-network connection 116 and the setup time for the transit network connection 126.

The delay time period 156 is set so that the inter-network connection 116 is routed through the transit network connection 126 as soon as possible after that transit network connection 126 has been set up so as to reduce idle time as much as possible. By continuously measuring the aforesaid setup times during ongoing operation, the delay time period 156 can be continuously readjusted by the adjustment device 154 so that, depending on the then-prevailing network conditions, the idle time is as short as possible without the inter-network connection 116 being routed through the transit network connection 126 before that transit network connection 126 has been set up.

The delay time period 156 can also be adjusted as a function of connection-specific setting operations that are performed by the connection controller 144. The local connection setup message 160 is thereby delayed depending on how the connection controller 144 performs such operations on a connection-specific information item contained in the local connection setup message 160.

Furthermore, the delay time period 156 can also be set as a function of connection setup messages that are received or passed on by the interworking unit 108 within the scope of the setup of the transit network connection 126. Examples of such setup messages are transit call processing messages (T CALL PROCEEDING) and call initiation messages (T CONNECT, T CONNECT ACK).

While the local connection setup message 160 is delayed in the interworking unit 108, the transit connection setup message 162 is sent out to the interworking unit 110 through the transit network 106. At each node of the transit network 106, receipt of the connection setup message 162 is confirmed with a transit call processing message (TRANSIT CALL PROCEEDING) that is sent to the preceding node. For example, transit call processing message 164 (T CALL PROCEEDING) is sent back to the interworking unit 108 from a first node of the transit network 106 in reaction to the transmission of the transit connection setup message 162. In an analogous fashion, when the T SETUP message travels through nodes to at its destination, the interworking unit 110 in turn sends a connection initiation message (T CONNECT) back to the preceding node of the transit network 106 in reaction to its receipt of a transit connection setup message T SETUP.

After the delay time period 156 has elapsed, the local connection setup message 160 (LOCAL SETUP) is read out of the memory 148 and sent out through the transit interface 140. The local connection setup message is sent to the interworking unit 110 through the transit network 106 using the previously set up transit signaling tunnel connection 124. The interworking unit 110 then transmits the local connection setup message 160 without delay into the local network 104. The setup of the inter-network connection 116 is continued by the transmission of the local connection setup message 160 to the connection destination, which is switching device 114.

In reaction to the receipt of the local connection setup message 160, the switching device 114 firstly sends a local connection initiation message 166 (L CONNECT) back to the preceding node and towards the switching device 112 via the transit signaling tunnel connection 124.

In parallel with this, the interworking unit 110 transmits a transit connection initiation message 168 (T CONNECT) towards the interworking unit 108 via the transit network 106 in reaction to the receipt of the transit connection setup message 162. The interworking unit 108 then confirms the receipt of the transit connection initiation message (T CONNECT) by transmitting a transit initiation confirmation message 170 (T CONNECT ACK) back to the preceding node in the transit network 106.

While the transit initiation confirmation messages 170 (T CONNECT ACK) are being transmitted back to preceding nodes to acknowledge acceptance of transit network connection 126, local connection initiation messages 166 (L CONNECT) continue to propagate from the switching device 114 back to the preceding node and towards the switching device 112 via the transit signaling tunnel connection 124. In response to each local connection initiation messages 166 (L CONNECT), each node sends back a local initiation confirmation message 172 to the preceding node. In addition, the switching device 114 sends a local call message 172 (LOCAL ALERT) back towards the switching device 112. The inter-network connection 116 and the transit network connection 126 are thus being set up for the most part simultaneously.

After each transit initiation confirmation message 170 (T CONNECT ACK) has been sent back to the preceding node from interworking unit 108 back towards interworking unit 110, the setup of the transit network connection 126 between the interworking units 108 and 110 is essentially complete. This transit network connection 126 is then used to complete the setup of the inter-network connection 116 between the switching devices 112 and 114 that was initiated by the local connection setup message 160 (LOCAL SETUP).

Finally, the local user data 130 is transmitted in a transparent fashion between the switching devices 112 and 114 through this inter-network connection 116.

In contrast to the prior art, the local connection setup message 160 is not delayed at the entry point 118 into the transit network 106 until the complete setup of the transit network connection 126, but rather only until the delay time period 156 has elapsed. The transmission of the local connection setup message 160 initiated the local connection setup at some time before the completion of the transit connection setup. Therefore, portions of the local connection setup are carried out in parallel with the transit connection setup in terms of time.

As a result of the delay of the local connection setup message 160 at the entry point 108 by the preset delay time period 156, the local connection setup is synchronized with the transit connection setup in such a way that the setup of the transit network connection 126 is, with a high degree of probability, completed if it is required for the inter-network connection 116. In order to increase this probability even further, the delay time period 156 can be readjusted by the adjustment device 154 during ongoing operation.

In accordance with the embodiment, the setup time for the inter-network connection 116 is essentially determined by the greater of the delay time periods for a pure transit network connection and for a pure inter-network connection. Generally, the setup time for a pure inter-network connection is greater, and the setup time for the inter-network connection 116 is only insignificantly longer than the setup time of the pure inter-network connection.

In the prior art, the setup time for an inter-network connection was, in contrast, determined by the sum of the setup times for a pure transit network connection and for a pure inter-network connection. The present invention thus makes it possible to reduce considerably the setup time for inter-network connections in comparison with the prior art without significant additional expenditure. This speed advantage is all the more pronounced the more transit networks there are between the switching devices 112 and 114, or between the local networks 102 and 104.

Although the present invention has been described in connection with certain specific embodiments for instructional purposes, the present invention is not limited thereto. In another specific embodiment, for example, a connection setup message is passed on through a signaling tunnel connection that is set up in the transit network. The signaling tunnel connection is set up in advance as a dedicated connection. A plurality of such signaling tunnel connections can be set up in advance between a plurality of, or all, the potential entry and exit points into and out of the transit network. The connection setup message can be passed on very quickly through the transit network via the signaling tunnel connection that is already set up. In contrast to user data connections for real time communication, signaling tunnel connections can be set up very cost-effectively as permanent dedicated connections in a large number of communications networks.

In a specific embodiment, during the initial setup of an inter-network connection, a sufficiently dimensioned delay time period can be predefined administratively if no measured values for preceding connection setup times are available. Alternatively, during the first inter-network connection setup, it is possible to wait for the setup of the transit network connection before the connection setup message is passed on.

In another embodiment, the connection setup message is buffered in the interworking unit. While the connection setup message is being delayed, the interworking unit makes one or more connection-specific settings using a connection-specific information item contained in the connection setup message. In this way, hardware and software settings can be made that relate to transmission parameters, connection parameters and service quality parameters. Thereupon, the connection setup message can additionally be delayed as a function of operations carried out on such parameters.

Accordingly, various modifications, adaptations, and combinations of various features of the described embodiments can be practiced without departing from the scope of the invention as set forth in the claims.

What is claimed is:

1. A method comprising:
(a) an entry point into a second network receiving a first connection setup message, the first connection setup message being transmitted between a first network and a third network so as to set up an inter-network connection between the first network and the third network;
(b) initiating the setup of a transit network connection through the second network, the receipt of the first connection setup message initiating the setup of the transit network connection;
(c) delaying the first connection setup message at the entry point by a first delay time period; and
(d) passing on the first connection setup message through the second network, said first delay time period being chosen so that the setup of the transit network connection is complete when the transit network connection is required to establish the inter-network connection through the second network.

2. The method of claim 1, wherein the first connection setup message is passed on through a broadband signaling tunnel connection within the second network.

3. The method of claim 1, wherein a setup time for the inter-network connection and a setup time for the transit network connection are measured, and
wherein a second delay time period for a subsequent connection setup message is set as a function of the difference between the setup time for the inter-network connection and the setup time for the transit network connection.

4. The method of claim 2, wherein a setup time for the inter-network connection and a setup time for the transit network connection are measured, and
wherein a second delay time period for a subsequent connection setup message is set as a function of the difference between the setup time for the inter-network connection and the setup time for the transit network connection.

5. The method of claim 4, wherein, while the first connection setup message is being delayed, an interworking unit references a connection-specific information item contained in the first connection setup message and adopts a connection-specific configuration.

6. The method of claim 1, wherein the inter-network connection is a narrowband network connection and the transit network connection is a broadband network connection.

7. A computer-readable medium having computer-executable instructions for performing steps comprising:
(a) receiving a first connection setup message, the first connection setup message being transmitted between a first network and a third network so as to set up an inter-network connection between the first network and the third network;
(b) in response to (a) initiating the setup of a transit network connection through a second network;
(c) delaying the first connection setup message by a first delay time period; and
(d) passing on the first connection setup message through the second network, said first delay time period being chosen so that the setup of the transit network connection is complete when the transit network connection is required to establish the inter-network connection through the second network.

8. The computer-readable medium of claim 7 having further computer-executable instructions for performing the steps of:
(e) measuring a setup time for the inter-network connection and a setup time for the transit network connection; and
(f) setting a second delay time period for a subsequent connection setup message as a function of the difference between the setup time for the inter-network connection and the setup time for the transit network connection.

9. An interworking unit for setting up an inter-network connection through a second network, comprising:
(a) a local interface that receives a connection setup message that is passed on through the second network and sets up the inter-network connection;
(b) a connection controller that interfaces the second network and, upon receipt of the connection setup message, sets up a transit network connection through the second network;
(c) a memory that buffers the connection setup message; and
(d) a timing gate that delays the passing on of the buffered connection setup message by a delay time period that is set such that the setup of the transit network connection is complete when the transit network connection is required to establish the inter-network connection through the second network.

10. The interworking unit of claim 9, further comprising a protocol controller that references a connection-specific information item contained in the first connection setup message and adopts a connection-specific configuration during the delay time period while the first connection setup message is being delayed.

11. The interworking unit of claim 9, further comprising
a time measuring device that measures a setup time for the inter-network connection and a setup time for the transit network connection; and
a delay adjustment device that sets a second delay time period for a subsequent connection setup message as a function of the difference between the setup time for the inter-network connection and the setup time for the transit network connection.

12. A method comprising:
(a) an entry point into a transit network receiving a first local connection setup message, the first local connection setup message being transmitted between two local networks so as to set up an inter-network connection between the two local networks;
(b) initiating the setup of a transit network connection through the transit network, the receipt of the first local connection setup message initiating the setup of the transit network connection;
(c) delaying the first local connection setup message at the entry point by a first delay time period; and
(d) passing on the first local connection setup message through the transit network, said first delay time period being chosen so that the setup of the transit network connection is complete when the transit network connection is required to establish the inter-network connection through the transit network.

13. The method of claim 12, wherein the first local connection setup message is passed on through a transit signaling tunnel connection within the transit network.

14. The method of claim 12, wherein a setup time for the inter-network connection and a setup time for the transit network connection are measured, and
wherein a second delay time period for a subsequent local connection setup message is set as a function of the difference between the setup time for the inter-network connection and the setup time for the transit network connection.

15. The method of claim 12, wherein the inter-network connection is a narrowband network connection and the transit network connection is a broadband network connection.

16. The method of claim 14, wherein, while the first local connection setup message is being delayed, an interworking unit references a connection-specific information item contained in the first local connection setup message and adopts a connection-specific configuration.

17. An interworking unit for setting up an inter-network connection through a transit network, comprising:
(a) a local interface that receives a local connection setup message that is passed on through the transit network and sets up the inter-network connection;
(b) a connection controller that interfaces the transit network and, upon receipt of the local connection setup message, sets up a transit network connection through the transit network;
(c) a memory that buffers the local connection setup message; and
(d) a timing gate that delays the passing on of the buffered local connection setup message by a delay time period that is set such that the setup of the transit network connection is complete when the transit network connection is required to establish the inter-network connection through the transit network.

18. The interworking unit of claim 17, further comprising a protocol controller that references a connection-specific information item contained in the first local connection setup message and adopts a connection-specific configuration during the delay time period while the first local connection setup message is being delayed.

19. The interworking unit of claim 17, further comprising
a time measuring device that measures a setup time for the inter-network connection and a setup time for the transit network connection; and
a delay adjustment device that sets a second delay time period for a subsequent local connection setup message as a function of the difference between the setup time for the inter-network connection and the setup time for the transit network connection.
